(19) United States
(12) Patent Application Publication
(10) Pub. No.: US 2012/0236153 A1
(43) Pub. Date: Sep. 20, 2012

(54) IMAGE PROCESSING APPARATUS, IMAGE PROCESSING METHOD AND MEDIUM FOR STORING IMAGE PROCESSING PROGRAM

(75) Inventors: Yasuhiro Aoki, Kawasaki (JP); Masami Mizutani, Kawasaki (JP)

(73) Assignee: FUJITSU LIMITED, Kawasaki (JP)

(21) Appl. No.: 13/422,711

(22) Filed: Mar. 16, 2012

Related U.S. Application Data
(63) Continuation of application No. PCT/JP2009/004701, filed on Sep. 17, 2009.

(51) Int. Cl. H04N 7/18

(52) U.S. Cl. 348/149; 348/E07.085

(57) ABSTRACT

An apparatus includes a first processing unit which performs correction in which an image acquired by a camera moving with a moving vehicle is displaced in a moving direction of the moving vehicle in accordance with a moving amount of the camera from a predetermined position on a moving path of the moving vehicle to an image acquiring position at which the camera acquires the image, a second processing unit which performs correction in which a size of the image acquired by the camera is changed in accordance with a distance between the area of the object and the camera when the camera acquires the image using a size of a predetermined image acquired by the camera and a distance corresponding to the predetermined image, and a third processing unit which arranges a plurality of images corrected by the first and the second processing units to generate an inspection image.

### CROSS-REFERENCE TO RELATED APPLICATION

This is a continuation of International Application No. PCT/JP2009/004701 filed on Sep. 17, 2009, the entire contents of which are incorporated herein by reference.

### FIELD

The embodiments discussed herein are related to an image processing apparatus, an image processing method and a medium for storing an image processing program for processing image data acquired from picking up an object.

### BACKGROUND

In structures, such as tunnels, changes in states including appearance of cracks or peeling may occur in concrete wall surfaces due to aged deterioration. Locations at which changes in states have occurred are inspected in order to ensure safety of the structures.

Visual inspection by a human inspector from the close position is high in cost and low in efficiency. It is considered to pick up images of a structure by a camera carried on a vehicle travelling along the structure in order to inspect the structure in shorter time and without obstructing traffic. For example, images of a tunnel wall surface are continuously picked up by the camera on the vehicle traveling along the wall surface of the tunnel to acquire a plurality of still image (each still image corresponds to a single frame). In this method, the vehicle carrying the camera travels between a point of time at which an image frame is picked up and a point of time at which the next image frame is picked up; therefore, positions of objects in a developed image, in which a plurality of picked up image frames are disposed in a rectangular frame, are not accurate. Further, if the distance between the camera and an object area varies in a case in which the structure, such as a wall surface of a tunnel, curves, and in a case in which the vehicle carrying the camera is not able to travel along the structure, the size of the object area differs in each of the image frames in the developed image.

The developed image of the tunnel is used to check the locations at which changes in states have occurred in the tunnel wall surface. If adjoining frames are joined in a misaligned manner or if the object areas differ in size among frames, there is a possibility that locations at which changes in states have occurred to be detected are not displayed on the developed image, or that a single location at which a change in state has occurred is displayed at two or more locations on the developed image.

Japanese Laid-open Patent Publication No. 2004-012152 is an example of the related art.

### SUMMARY

According to an aspect of the invention, an image processing apparatus includes a camera which acquires an image of an area of an object while moving with a moving vehicle, a moving amount acquisition unit which acquires a moving amount of the camera from a predetermined position on a moving path of the moving vehicle to an image acquiring position at which the camera acquires the image of the area, a distance acquisition unit which acquires a distance between the area of the object and the camera when the camera acquires the image of the area, a first processing unit which performs correction in which the image acquired by the camera is displaced in a moving direction of the moving vehicle in accordance with the moving amount, a second processing unit which performs correction in which a size of the image acquired by the camera is changed in accordance with the distance acquired by the distance acquisition unit using a size of a predetermined image acquired by the camera and a distance corresponding to the predetermined image, and a third processing unit which arranges a plurality of images corrected by the first processing unit and the second processing unit to generate an inspection image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an image processing apparatus according to a first embodiment;

FIG. 2 is a schematic diagram illustrating continuous acquisition of a plurality of image frames by a camera moving along a wall surface and scanning the wall surface in a direction which crosses the moving direction of the camera;

FIG. 3 illustrates a flow of a normalization process of an image processing apparatus of a first embodiment;

FIG. 4 illustrates a coordinate system of an input image acquired by the image pick-up unit of the first embodiment;

FIG. 5 illustrates a moving-direction expansion and contraction process accompanying a normalization process of a distance of an acquired image;

FIG. 6 illustrates a moving-direction movement process of an image for which a moving-direction expansion and contraction process has been performed accompanying the normalization process of a moved amount;

FIG. 7 illustrates an image frame for which the expansion and contraction process and the moving-direction movement process have been performed;

FIG. 8 is a sectional view illustrating picking-up of images by scanning the wall surface in the vertical direction;

FIG. 9 is a sectional view illustrating expansion and contraction in a scanning direction accompanying the normalization process of the distance;

FIG. 10 illustrates an image after the normalization process;

FIG. 11 is a graph illustrating a relationship between a vertical direction y of each acquired image and a vertical direction y′ of each image after the normalization process;

FIG. 12 is a flowchart of a normalization process of an acquired image;

FIG. 13 is a flowchart since a still image is picked up until a developed image is output;

FIG. 14 is a developed image which is generated from a picked up image of the wall surface illustrated in FIG. 2 using the image processing apparatus of the first embodiment;

FIG. 15 illustrates an image processing apparatus of a modification of the first embodiment;

FIGS. 16A to 16C are schematic diagrams illustrating an exemplary combination process of image frames adjoining in the moving direction performed by a combination processing unit;

FIG. 17 is a flowchart illustrating an exemplary combination process of the image frames adjoining in the moving direction performed by the combination processing unit performs;

FIG. 18 is a configuration diagram of an image processing apparatus of the second embodiment;

FIGS. 19A to 19D illustrate a centering boundary detection unit;

FIGS. 20A and 20B illustrate the centering boundary detection unit;

FIG. 21 illustrates the centering boundary detection unit;

FIG. 22A is an outbound developed image 51 of an outbound developed image;

FIG. 22B is an inbound developed image 55 of an inbound developed image;

FIG. 22C is an inbound developed image 55 acquired by performing an expanding and contracting process for the inbound developed image;

FIG. 23A is the same outbound developed image 51 as that in FIG. 22A;

FIG. 23B is the inbound developed image 55 for which the expansion and contraction process has been performed in the same manner as that in FIG. 22C;

FIG. 23C is an inbound and outbound developed image acquired by combining the outbound developed image 51 and the inbound developed image 55 for which the expansion and contraction process has been performed;

FIG. 24 is a flowchart of a first outbound developed image generating process;

FIG. 25A is the inbound developed image 55 acquired by performing an expansion and contraction process for the outbound developed image 51;

FIG. 25B is the inbound developed image 55 acquired by performing an expansion and contraction process for the inbound developed image 55;

FIG. 25C is an inbound developed image 55 acquired by performing an expansion and contraction process for the inbound developed image;

FIG. 26 is a flowchart of a second outbound developed image generating process; and

FIG. 27 is a schematic diagram illustrating an exemplary image processing apparatus of the first embodiment implemented using a general computer.

### DESCRIPTION OF EMBODIMENTS

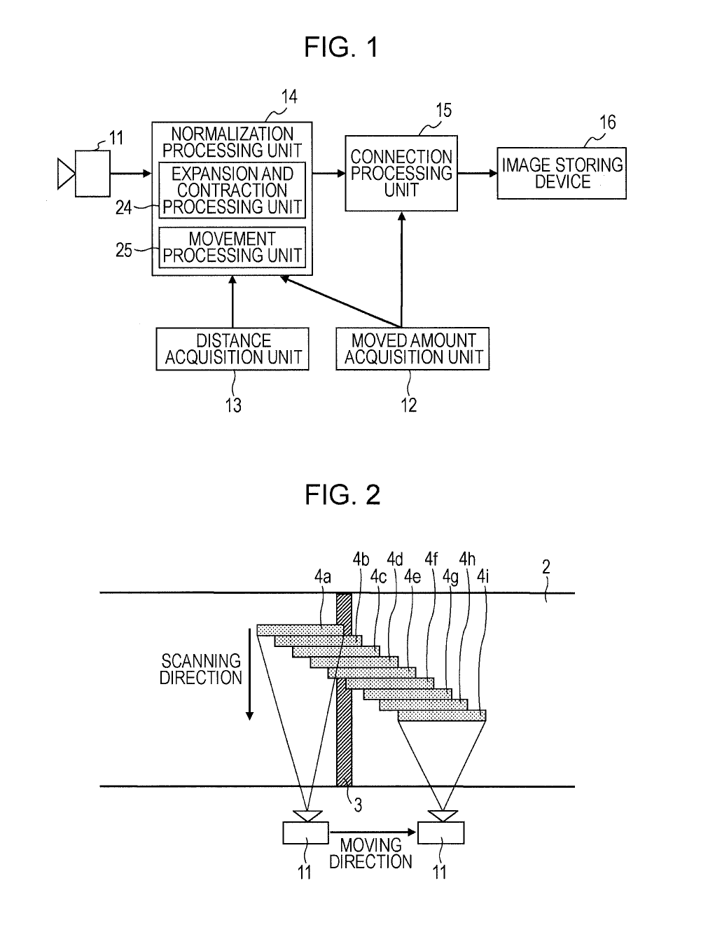

FIG. 1 illustrates an image processing apparatus of a first embodiment. The image processing apparatus of the present embodiment includes a camera 11, a moved amount acquisition unit 12 and a distance acquisition unit 13. The image processing apparatus of the present embodiment includes a normalization processing unit 14 and a combination processing unit 15.

The camera 11 picks images of an object repeatedly while moving and acquires image data. The camera 11 may be selected arbitrarily and may be, for example, a linear sensor camera with visual sensors arranged in one dimensional direction and an area sensor camera with visual sensors arranged in two dimensional directions. The data acquired by image picking-up of the linear sensor camera is one-dimensional image data and the data acquired by image picking-up of the area sensor camera is two-dimensional image data. An infrared camera is preferably used which is capable of easily detecting deterioration, such as cracks and peeling, of a structure of an object.

The camera 11 may be moved in arbitrarily selected manner. The camera 11 is carried and moved on a moving device, such as a car. The camera 11 may pick up the image of the object by scanning the object in a direction which crosses the direction in which the moving device is moving. The direction which crosses the direction in which the moving device is moving is, for example, perpendicular to the moving direction. For example, the object may be scanned by picking up images by the camera 11 which is rotated such that a straight line between a sensor of the camera 11 and the object is rotated about a straight line extending in the moving direction. For example, the camera 11 scans the object from the top to the bottom, and then repeats the scanning from the top to the bottom. A device for scanning the object is provided to the camera 11. The device adjusts the orientation and position of the camera 11. A scanning camera in which an operation mechanism for scanning an object is incorporated may be used. Hereinafter, a scanning linear sensor camera is used in the present embodiment. The scanning linear sensor camera picks up an image of object while being rotated such that a straight line between a sensor and the object is rotated about a straight line extending in the moving direction of the moving device.

The moved amount acquisition unit 12 is a device which acquires a moved amount of the camera 11 from a predetermined position to an image pick-up position. An exemplary moved amount acquisition unit 12 is a device which measures a moved amount of the camera 11 in the moving direction in a period since the camera 11 picks up an image until the camera 11 picks up another image. The moved amount is usually acquired in synchronization with picking up of the image by the camera 11. The moved amount acquisition unit 12 is not particularly limited: any moved amount sensor which measures the moved amount of the camera 11 in the moving direction of the moving device may be used. When the camera 11 is mounted on a vehicle, for example, a vehicle speed sensor provided in the vehicle may be used as the moved amount sensor. The vehicle speed sensor measures the moved amount of the vehicle from a predetermined position to an image pick-up position (e.g., the moved amount of the vehicle moved between a position at which an image is picked up and a position at which another image is picked up) in accordance with pulse signals generated by a vehicle speed pulse generator in proportion to the rotational speed of a vehicle shaft. A distance sensor capable of measuring the distance between the object area and the camera 11 during pick-up of an image may be used as the distance acquisition unit 13: in that case, the moved amount acquisition unit 12 may be a device which calculates the moved amount of the camera on the basis of each distance measured by the distance sensor at a plurality of image pick-up events, and of an amount of change of a feature point of the image data acquired in the plurality of image pick-up events. The amount of change in the feature point of the image data is acquired on, for example, a pixel basis. For example, an amount of change is converted on the pixel basis into an actual amount of change (e.g., meters) by multiplying the actual dimension size of a single image pick-up element by an amount of change of the feature point. An average value of the plurality of distance values acquired in the plurality of image pick-up events is calculated. The moved amount of the camera may be calculated by the following formula:

moved amount of camera=average value of distance x actual dimension of pixel/focal length.

The distance acquisition unit 13 is a device which acquires the distance between an object of the structure and the camera 11 when the camera 11 picks up an image of the object area. The distance is usually acquired in synchronization with picking up of the image by the camera 11. The distance acquisition unit 13 is not particularly limited: for example, a distance sensor, such as a range sensor, which measures the distance to an object by applying a laser beam, an ultrasonic wave and so on against the object and measuring the time until the light reflected from the object may be used. A vehicle speed sensor capable of measuring the moved amount from a predetermined position to the image pick-up position, such as a vehicle speed pulse generator, may be used as the moved amount acquisition unit 12: in that case, the distance acquisition unit 13 may be a device which calculates the distance from the moved amount measured by the moved amount sensor at the time of a plurality of image pick-up events, and the distance from the center of each image data acquired by the plurality of image pick-up events to a feature point of each image data. At each image pick-up position, an angle between a straight line connecting a position of the object corresponding to the feature point and camera 11 and a straight line in the moving direction of the camera 11 moved by the moving device may be calculated by multiplying the distance (on a pixel basis) from the center of each image data acquired by the plurality of image pick-up event to the feature point of each image data by a viewing angle of a pixel. The distance from the camera 11 to the object may be calculated on the basis of the moved amount of the camera 11 and the angle in each image pick-up position (triangulation).

The normalization processing unit 14 includes a movement processing unit 25 (i.e., a first processing unit) and an expansion and contraction processing unit 24 (i.e., a second processing unit or a fifth processing unit). The movement processing unit 25 performs correction such that frames of a plurality of pieces of image data picked up by the camera 11 are displaced in the moving direction of the moving device in accordance with the moved amount of the camera 11 from a predetermined position to an image pick-up position. The expansion and contraction processing unit 24 performs correction such that a frame size of image data picked up by the camera 11 in accordance with the distance acquired by the distance acquisition unit 13 is expanded and contracted with reference to the frame size of predetermined image data and the predetermined distance corresponding to the image data. The normalization process is performed on a certain coordinate axis regarding a plurality of image frames acquired, for example, by a single scanning event of the object in the scanning direction. Details of the normalization processing unit 14 will be described below.

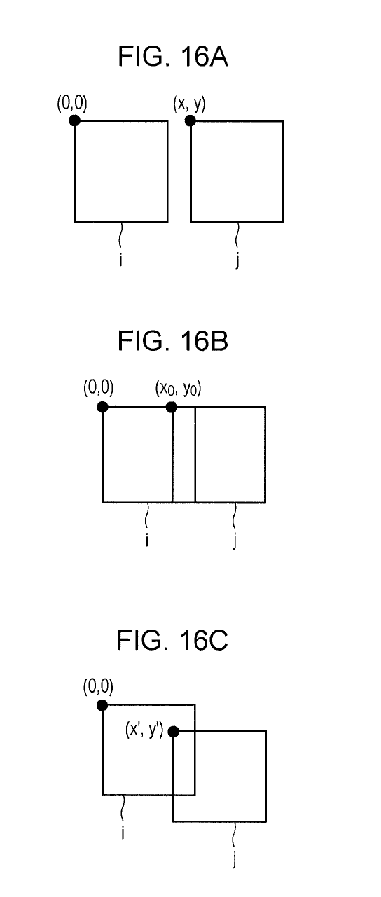

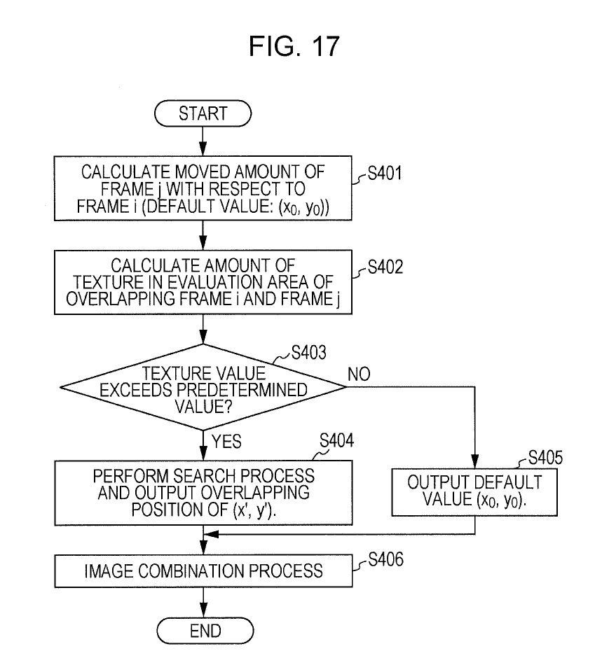

The combination processing unit 15 (i.e., a third processing unit or a sixth processing unit) plots the plurality of pieces of image data corrected by the movement processing unit 25 and the expansion and contraction processing unit 24 on a two-dimensional coordinate system, and generates a two-dimensional image. The two-dimensional image data may be generated by calculating positions of the image frames adjoining in the moving direction on the basis of the moved amount of the camera 11 acquired by the distance acquisition unit 13 during the pick-up of a plurality of images. Although a plurality of image frames may be disposed on a two-dimensional coordinate system depending only on the distance acquisition unit 13, it is preferred to correct a plurality of image frames in the moving direction of the camera as needed from the viewpoint of reduction in misalignment of the objects plotted on the acquired two-dimensional image. The moving direction of the camera may be corrected by: correcting such that the difference absolute value sum of image pixel values (i.e., pixel values) of an area in which two adjoining image frames overlap each other may become the smallest; and correcting using a matching method by normalized correlation of the image pixel values in an area in which two adjoining image frames overlap. An exemplary combination process will be described later with reference to FIGS. 16A to 16C and 17.

The image processing apparatus of the present embodiment may be provided with an image storing device 16 in which an image (i.e., a developed image) plotted on a two-dimensional coordinate system is stored.

FIG. 2 is a schematic diagram illustrating continuous acquisition of a plurality of the image frames by the camera moving along a wall surface and scanning the wall surface in a direction which crosses the moving direction of the camera. The camera 11 is a scanning linear sensor camera. A visual sensor of the camera 11 is disposed to extend in the moving direction. The camera 11 picks up images of the wall surface 2 while moving along the wall surface 2 of a tunnel. During the pick-up of the images, the camera 11 scans the wall surface 2 from the top to the bottom and picks up still images a plurality of times. The camera 11 scans the wall surface 2 from the top to the bottom from one end to the other end of the tunnel a plurality of times. In the present embodiment, the image of the wall surface 2 is picked up by a linear sensor camera in which a plurality of image pick-up elements are arranged linearly in the moving direction; each of the image pick-up elements acquires a single pixel. In FIG. 2, adjacent object areas 4a to 4i partially overlap one another. It is desired to pick up images while scanning such that adjacent object areas partially overlap one another.

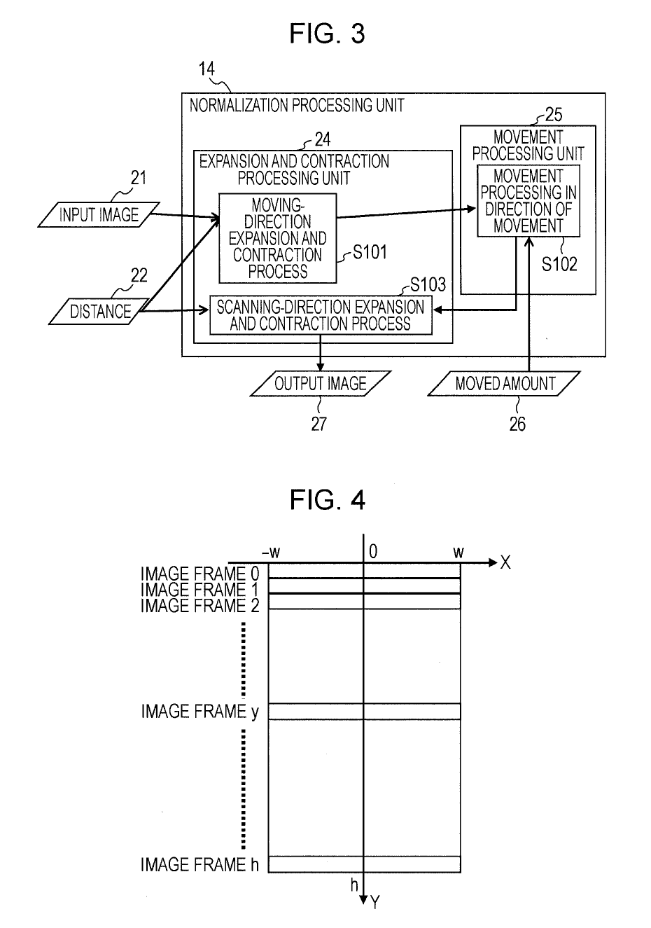

FIG. 3 illustrates a flow of a normalization process of the image processing apparatus of the present embodiment. The normalization processing unit 14 of the image processing apparatus of the present embodiment includes an expansion and contraction processing unit 24 and a movement processing unit 25. The expansion and contraction processing unit 24 acquires a plurality of input images 21 picked up by the camera 11 and distance 22 between the object area and the camera 11 acquired by the distance acquisition unit 13. The movement processing unit 25 acquires a moved amount 26 in the moving direction during a period since a certain image is picked up until the next image is picked up, which is acquired by the moved amount acquisition unit 12.

The normalization process includes a moving-direction expansion and contraction process S101 and a moving-direction movement process S102 which are moving-direction process of the image frame, and a scanning-direction expansion and contraction process S103 which is a scanning-direction process. The expansion and contraction processing unit 24 performs the moving-direction expansion and contraction process S101 and the scanning-direction expansion and contraction process S103. The movement processing unit 25 performs the moving-direction movement process 102.

Output image data 27 for which the moving-direction expansion and contraction process S101, the moving-direction movement process S102 and the scanning-direction expansion and contraction process S103 have performed is combined in the combination processing unit 15 and thereby two-dimensional image data is generated.

The illustrated components are functional and conceptual examples and thus do not physically correspond to actual components. That is, specific forms of distribution and integration of each device is not limited to those illustrated; but each device may be partially or entirely distributed and integrated functionally or physically in an arbitrary unit.

FIG. 4 illustrates a coordinate system of input image data acquired by a camera. An X-axis represents a moving direction (i.e., the horizontal direction) and a Y-axis represents a scanning direction (i.e., the vertical direction). Here, the width of the input image (corresponding to the number of elements on a scanning line) is 2w; the height of the input image (i.e., the number of scanning lines) is h, an upper left point of the image is (−w, 0) and the lower right point of the image is (w, h).

Moving-Direction Expansion and Contraction Process

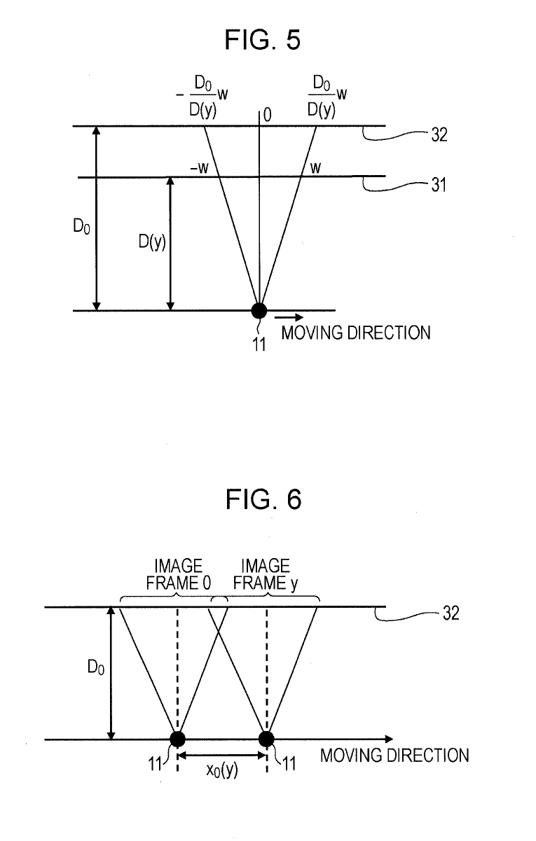

The moving-direction expansion and contraction process will be described with reference to FIG. 5. FIG. 5 illustrates a moving-direction expansion and contraction process accompanying a normalization process of a distance of an acquired image frame. The distance between the camera 11 and the wall surface 31 of which images are picked up when the image frame y to be processed is picked up is acquired by the distance acquisition unit 13 as D(y). The distance between the camera 11 and a virtual wall surface 32 which is to be normalized is set to D0. In this process, each image frame acquired by the camera 11 is corrected such that as if all of the image frames are seen from predetermined distance D0 in the X-axis direction. In particular, an X coordinate after the moving-direction expansion and contraction process of the image frame y is performed is calculated by, for example, using the following formula (1).

$${x}_{1} = \frac{{D}_{0}}{D ( y )} x \qquad ( 1 )$$

where x represents the X coordinate of the input image and x1 represents the X coordinate after the moving-direction expansion and contraction process is performed.

Moving-Direction Movement Process

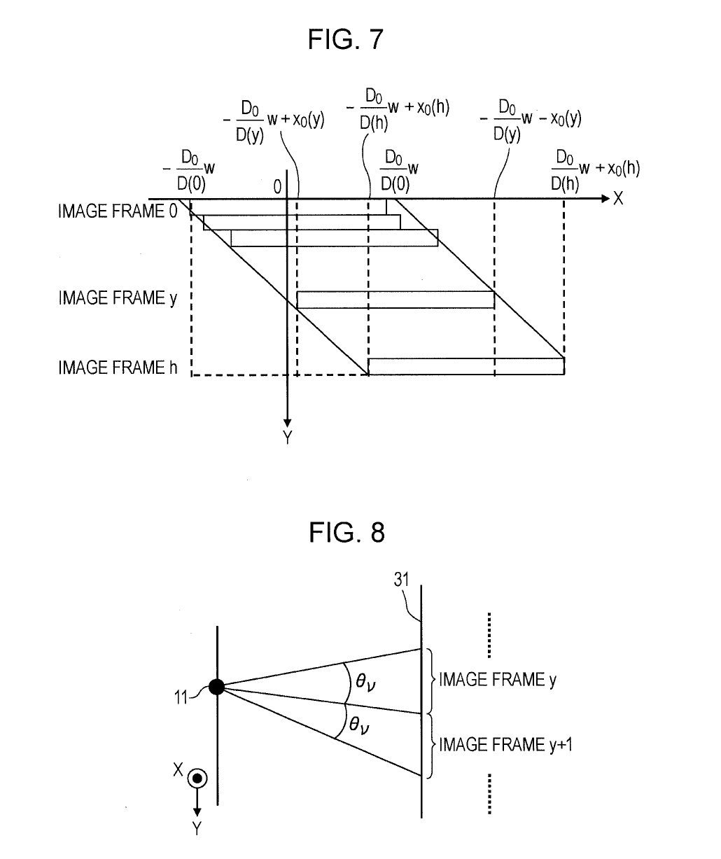

The moving-direction movement process will be described with reference to FIGS. 6 and 7. FIG. 6 illustrates a moving-direction movement process of an image for which a moving-direction expansion and contraction process has been performed accompanying the normalization process of a moved amount. Since the camera 11 is moved along the wall surface, the object area of each image frame is moved in the moving direction with the elapse of time. In this process, positions of other image frames in the X-axis direction with respect to a reference position (e.g., an X coordinate of the center of an image frame 0 (=0)) of the X-axis of a reference image frame are calculated. The moved amount of the image frame y with respect to the image frame 0 is herein acquired as x0 (y) by a moved amount acquisition unit (unit: pixel).

Correction is made in the moving direction by moving other image frames y by x0 (y). Accordingly, the X coordinate x′ after the moving-direction movement process may be expressed by linear transformation of the following formula (2).

$$\begin{matrix}{x}^{′} = {x}_{1} + {x}_{0} ( y ) \\ = \frac{{D}_{0}}{D ( y )} x + {x}_{0} ( y )\end{matrix} \qquad ( 2 )$$

FIG. 7 illustrates an image frame for which the expansion and contraction process and to the moving-direction movement process have been performed. Each image frame y is moved in parallel translation in the X-axis direction by +x0 (y) with reference to the image frame 0.

Scanning-Direction Expansion and Contraction Process

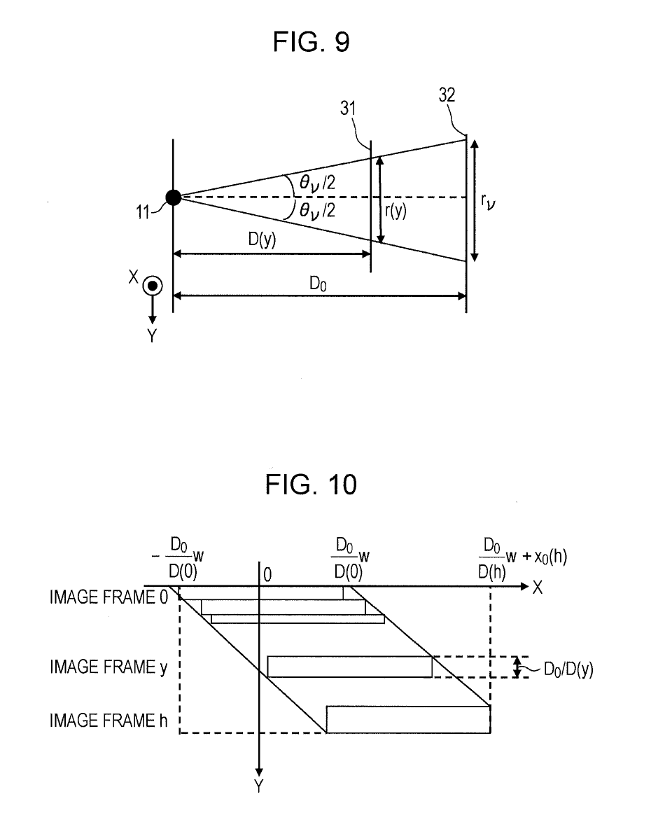

An expansion and contraction process in the scanning (vertical) the direction will be described with reference to FIGS. 8 and 9. FIG. 8 is a sectional view illustrating picking-up of images by scanning the wall surface in the vertical direction. FIG. 8 illustrates the wall surface 31 and a cross section perpendicular to the X-axis direction of the camera 11. Each time the camera 11 is rotated by θv about a line in the X-axis direction passing through the camera 11, a still image is picked up and the image frame y and the image frame y+1 are acquired sequentially. FIG. 9 is a sectional view illustrating expansion and contraction in the scanning direction accompanying the normalization process of the distance. In this process, each image frame is corrected such that all the image frames are seen from a predetermined distance D0 in the y-axis direction. The distance between the image pick-up center of the camera 11 and the image frame y is acquired as D(y) by the distance acquisition unit 13. A vertical visual field r(y) of each image frame y is calculated approximately by the following formula (3).

r(y)=2D(y)tan(θᵥ/2) (3)

The vertical visual field rv when the images of the virtual wall surface 32 are picked up after the normalization process for the distance is completed may be calculated using the following formula (4). After the normalization process for the distance is completed, the distance from the center of the pick-up center of the camera 11 is D0.

rᵥ=2D₀ tan(θᵥ/2) (4)

An enlargement and reduction ratio s (y) of each image frame y may be calculated using the following formula (5) from the similarity ratio.

$$s ( y ) = \frac{{r}_{v}}{r ( y )} = \frac{{D}_{0}}{D ( y )} \qquad ( 5 )$$

That is, each image frame y is expanded and contracted at an expansion and contraction ratio D0/D(y) in the scanning-direction expansion and contraction process. The relationship between the position y of the image frame in the scanning direction and the position y′ in the scanning direction after the normalization may be expressed in following formula (6) in a cumulative format.

$${y}^{′} = \frac{1}{{D}_{0}} {\sum }_{k = 0}^{y} D ( y ) \qquad ( 6 )$$

The normalization process of the present embodiment is performed by the above-described moving-direction expansion and contraction process, the moving-direction movement process and the scanning-direction expansion and contraction process. FIG. 10 illustrates an image after the normalization process. After the normalization process, the image frames are arranged in a state in which each image frame of the acquired image is expanded and contracted.

The processes described above may be performed substantially in an arbitrary order; but it is desired the moving-direction expansion and contraction process and the moving-direction movement process precede a vertical-direction expansion and contraction process. The moving-direction expansion and contraction process and the moving-direction movement process may be efficiently processed with the height of each pixel frame corresponds to a single pixel (unit: pixel). However, since the height of each pixel frame becomes D0/D(y) after the vertical-direction expansion and contraction process is performed, the data for which the moving-direction expansion and contraction process and the moving-direction movement process are to be performed is usually no longer a pixel unit. Therefore, the moving-direction expansion and contraction process and the moving-direction movement process become inefficient.

The moving-direction expansion and contraction process preferably precedes the moving-direction movement process. Performing the moving-direction movement process before the moving-direction expansion and contraction process means that the above-described formula (2) regarding X coordinate x′ after the moving-direction movement process is transformed as expressed by the following formula (7).

$$\begin{matrix}{x}^{′} = {x}_{1} + {x}_{0} ( y ) \\ = \frac{{D}_{0}}{D ( y )} x + {x}_{0} ( y ) \\ = \frac{{D}_{0}}{D ( y )} ( x + \frac{D ( y )}{{D}_{0}} {x}_{0} ( y ) ) ( 7 )\end{matrix} \qquad ( 2 )$$

In the formula (7), addition (D(y)/D0) (y) x0 of x in parenthesis is a movement correction in the moving direction. This addition is inefficient because it means correcting the acquired moved amount x0(y) in accordance with the acquired distance D(y).

Therefore, the normalization process is preferably performed in the order of the moving-direction expansion and contraction process, the moving-direction movement process and the scanning-direction expansion and contraction process.

The above-described normalization process represents each pixel in the acquired image is converted into which pixel by the normalization. In actual conversion of an image, however, the quality of transformation result becomes high when inverse transformation is performed. In the inverse transformation, information about the correspondence between each pixel in the normalized image and the pixel in the acquired image is acquired.

The inverse transformation in the X-axis direction is linear transformation and thus acquired analytically by the following formula (8).

$$x = \frac{D ( y )}{{D}_{0}} \{ {x}^{′} - {x}_{0} ( y ) \} \qquad ( 8 )$$

The inverse transformation in the y-axis direction is acquired by numerical computation since the relationship between the position y of the image frame in the scanning direction and the position y′ in the scanning direction after the normalization is cumulative format as illustrated in the formula (6).

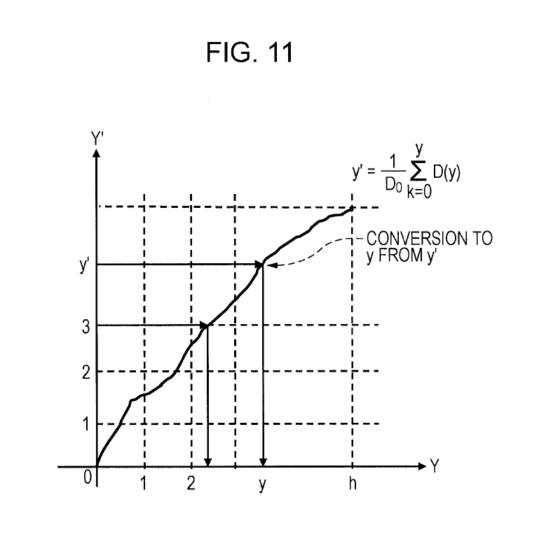

FIG. 11 is a graph illustrating a relationship between a vertical direction y of each acquired image and a vertical direction y′ of each image after the normalization process in accordance with the formula (6). The inverse transformation may be performed with reference to, for example, the graph of FIG. 11.

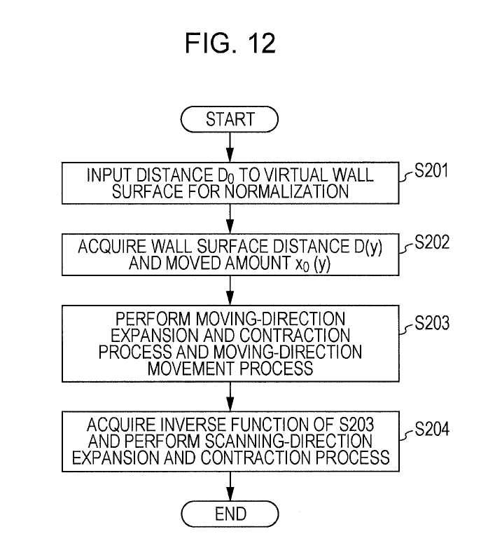

FIG. 12 is a flowchart illustrating that the image processing apparatus of the present embodiment performs the normalization process of an image after being picked up. First, the distance D0 from the camera 11 to the virtual wall surface for normalization is input in the expansion and contraction processing unit 24 (S201). Then, the normalization processing unit 14 acquires the wall surface distance D(y) and the moved amount x0(y) corresponding to each image frame (i.e., the input image 21) picked up by the camera 11 from the distance acquisition unit 13 and the moved amount acquisition unit 12, respectively (S202). Subsequently, the expansion and contraction processing unit 24 and the movement processing unit 25 perform the moving-direction expansion and contraction process and the moving-direction movement process in accordance with the above-described formula (8) regarding each of a plurality of input images input by the camera 11 (S203). Subsequently, for each image processed in S203, the expansion and contraction processing unit 24 performs the scanning-direction expansion and contraction process using the inverse function of the above-described formula (6) and outputs an output image 27 (S204).

The image processing apparatus of the present embodiment forms an image by, after the normalization process of each image is performed, performing the combination process of the output image 27 for which the normalization process has been performed by the combination processing unit 15, and then outputs the formed image.

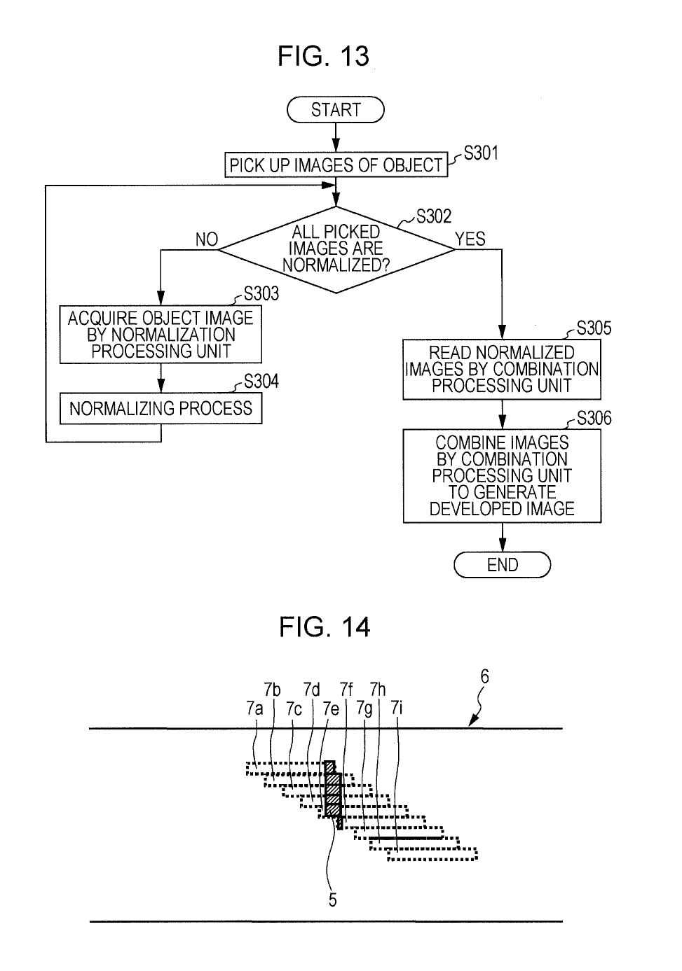

FIG. 13 is a flowchart from the image data acquisition to the image output. First, images of the structure which is an object are picked up by the camera 11 (S301). Subsequently, the normalization processing unit 14 acquires the image data of the object and performs the normalization process until the normalization process for all pieces of the acquired image data is completed (S302 to S304). In S302, upon completion of the normalization process of all pieces of image data of the object, the combination processing unit 15 reads the normalized image data, combines the images and generates the image (S305 and S306).

FIG. 14 is a generated image (i.e., a developed image) which is generated from a picked up image of the wall surface illustrated in FIG. 2 using the image processing apparatus of the present embodiment. An image 6 only includes image frames 7a to 7i which correspond to the object areas 4a to 4i in FIG. 2 and a pattern 5 which corresponds to a pattern 3 of the wall surface. The image processing apparatus of the embodiment picks up the images while traveling along the tunnel. The travelling speed is vulnerable to change. However, the pattern 5 of the wall surface on the image 6 has not been displaced. Even if the travelling speed or the distance between the image processing apparatus and the wall surface varies, the size of the image pick-up object appearing in each image frame is normalized and adjoining images may be combined. The image acquired by the image processing apparatus of the present embodiment may correctly recognize the position of the pattern 5 which corresponds to the pattern 3 on the wall surface.

According to the image processing apparatus of the present embodiment, an image with which defects and the position of the pattern on the wall surface may be recognized correctly may be generated by picking up images of the object by scanning in the direction which crosses the moving direction while travelling along the object, and by performing the normalization process and the combination process for a plurality of acquired still images.

An area sensor camera may be used as the camera 11 as stated above. In that case, since the distance between the camera 11 and the object area of the structure is usually considered the same value in each of the acquired image frames, there is a possibility that precision of the normalization result may become low as an area of the object of which images are to be picked up in each image frame becomes large. However, the area sensor camera is preferred in that it may pick up images of the structure in a short time.

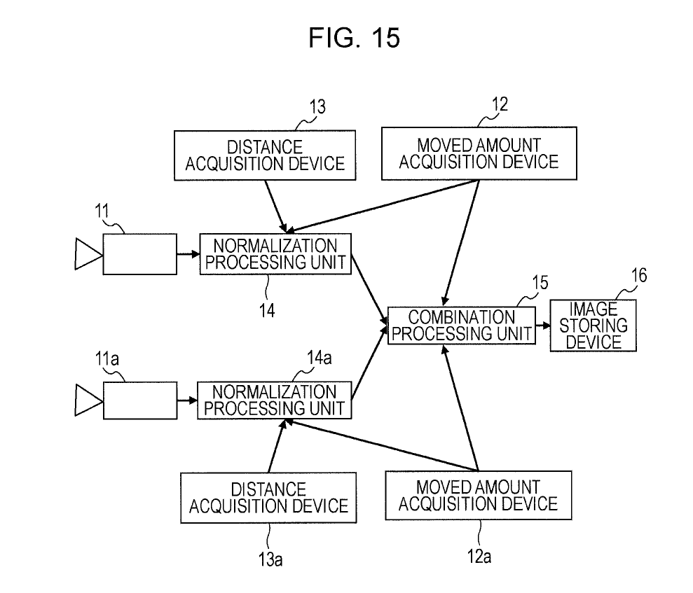

FIG. 15 illustrates an image processing apparatus of a modification of the first embodiment. Configurations similar to those in the image pick-up of the first embodiment will be denoted by the similar reference numerals and description thereof will be omitted. The image processing apparatus of this modification includes a camera 11, a moved amount acquisition unit 12, a distance acquisition unit 13, a normalization processing unit 14 and a combination processing unit 15 as in the image processing apparatus of the first embodiment. The image processing apparatus of this modification further includes a camera 11a, a normalization processing unit 14a, a moved amount acquisition unit 12a and a distance acquisition unit 13a. The normalization processing unit 14a processes an image acquired from the camera 11a. The moved amount acquisition unit 12a measures a moved amount or a travelling speed of the camera 11a in the moving direction in a period since the camera 11a picks up an image until the camera 11a picks up the next image. The distance acquisition unit 13a acquires the distance between an object area of the structure and the camera 11a when the camera 11a picks up an image. The camera 11 and the camera 11a travel while scanning different areas of the structure of which images are to be picked up. Relative positions, directions of view, difference in image pick-up timing and so on of the camera 11 and the camera 11a may be determined arbitrarily. Each image frame for which the normalization process is performed by the normalization processing units 14 and 14a is input in the combination processing unit 15, where a combination process is performed. According to the image processing apparatus of this modification, an image with which defects and the position of the pattern on the wall surface may be recognized may be generated as in the above-described first embodiment.

FIGS. 16A to 16C are schematic diagrams illustrating an exemplary combination process of image frames adjoining in the moving direction performed by a combination processing unit. As illustrated in FIG. 16A, an upper left vertex of an image frame i before the combination process is completed is set to (0, 0) and an upper right vertex of the image frame i is set to (x, y). First, theoretical overlapping position of adjoining frame images is set as a search start position (i.e., a default value) (FIG. 16B). The upper left vertex of the image frame i is set to (0, 0) and the upper right vertex of the image frame i is set to (x0, y0). The search start position may be computed using, for example, vehicle speed movement information. Subsequently, an image search process is performed in which an overlapping state of the image frames i and j adjoining in the moving direction are evaluated while shifting the relative positions of the image frames i and j and then searches a position with the highest evaluation value (FIG. 16C). Here, the upper left vertex of the image frame i is set to (0, 0) and the upper left vertex of the image frame i is set to (x′, y′). Subsequently, a combination process in which adjoining frame image are combined in accordance with the position with the highest evaluation value is performed. For example, the difference absolute value sum of the image pixel value in the image pixel of the area in which the image frames i and j overlap each other (i.e., the evaluation area) may be used for the evaluation of an overlapping state. Usually, a smaller difference absolute value sum means that the image frame i and the image frame j are overlapping each other with a smaller amount of misalignment.

If the text feature amount in the evaluation area for the evaluation of overlapping state is insufficient, the position of the search result may be inaccurate. The amount of texture in the evaluation area is evaluated in advance and if the evaluated texture amount is smaller than a predetermined amount of texture, a default value may be used without performing the image search process. The text feature amount herein is, for example, the distribution of a brightness value and the distribution of a brightness differential value.

FIG. 17 is a flowchart illustrating an exemplary combination process of the image frames adjoining in the moving direction performed by the combination processing unit performs. The search start position of the image frame j with respect to the image frame i is calculated (S401) and the text feature amount of an evaluation area in which the image frame i and the image frame j overlap each other is calculated (S402). If the text feature amount is not smaller than the predetermined value (S403), a search process is performed and an overlapping position is output (S404). If the text feature amount is smaller than the predetermined value (S403), the search start position is output (S405). An image combination process is performed in accordance with the position of the image frame j with respect to the image frame i output in S404 and S405 (S406).

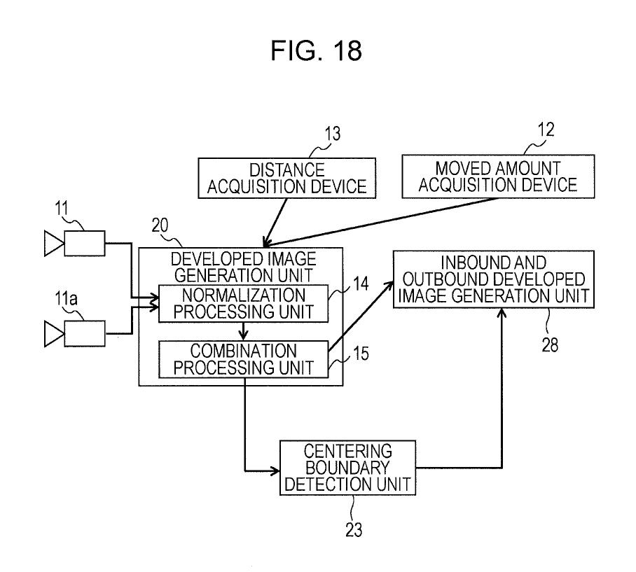

FIGS. 18 to 26 illustrate an image processing apparatus of the second embodiment. The image processing apparatus of the second embodiment is a device which detects a centering boundary position and generates an inbound and outbound developed image of high quality without misalignment of centering boundary on the basis of information about the detected center boundary position. The centering is an arch-shaped mold support for placing lining concrete. A linear joint of concrete exists on the tunnel wall surface over the circumference of the tunnel. This joint depends on the form of the mold support. In the present embodiment, the centering boundary means this joint.

FIG. 18 is a configuration diagram of an image processing apparatus of the second embodiment. The same components as those in the first embodiment are denoted by the same reference numerals and description thereof will be omitted.

The image processing apparatus of the second embodiment is mounted on a moving device, such as a vehicle, and picks up images of one side of the wall surface of the tunnel while travelling in the tunnel. The image processing apparatus of the second embodiment includes cameras 11, 11a, a distance acquisition unit 13, a moved amount acquisition unit 12, a developed image generation unit 20, a center boundary detection unit (i.e., a detection unit) 23 and an inbound and outbound developed image generation unit 28 (i.e., a fourth processing unit). The cameras 11 and 11a are the same as those provided in the image processing apparatus of the modification of the first embodiment illustrated in FIG. 15. The distance acquisition unit 13 and the moved amount acquisition unit 12 are the same as those of the first embodiment, and description thereof will be omitted. The developed image generation unit 20 includes the normalization processing unit 14 and the combination processing unit 15 in the image processing apparatus of FIG. 1. The normalization processing unit 14 performs the normalization process is performed for a plurality of image frames picked up by the cameras 11 and 11a on the basis of the moved amount and the distance, and the combination processing unit 15 combines the image frames for which the normalization process has been performed, thereby generating a developed image. With the thus-configured image processing apparatus, the developed image of the wall surface of one side of the tunnel is generated. This image processing apparatus collects image frames (i.e., image data) of the wall surface of each side while travelling outbound and inbound, and generates the outbound developed image and the inbound developed image.

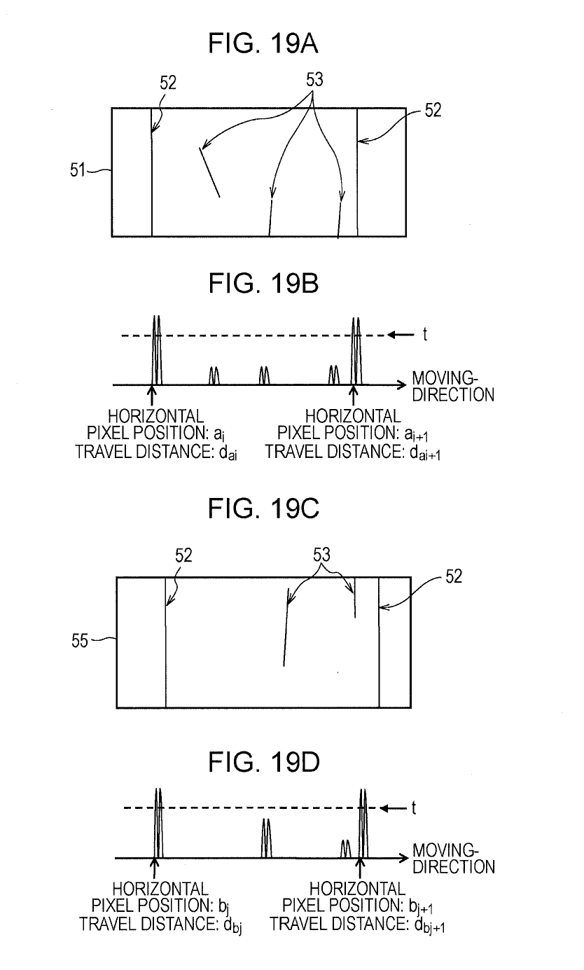

A center boundary detection unit 23 detects data about the centering boundary by the centering detection unit from the generated outbound developed image and inbound developed image. FIGS. 19A to 19D, 20A, 20B and 21 illustrate a centing boundary detection unit.

FIG. 19A illustrates the outbound developed image 51 and FIG. 19C illustrates the inbound developed image 55. In each of the outbound developed image and the inbound developed image, data of a line 53 in the scanning direction extending partially across the image in the longitudinal direction and data of a line 52 in the scanning direction extending across the image in the longitudinal direction may be detected as different data by image processing. The data of a line 52 in the scanning direction extending across the image in the longitudinal direction of the outbound or inbound developed image is detected by the image processing as data representing the joint of centering. The camera 11 is preferably an infrared camera because the centering boundary is acquired as data having temperature explicitly different from those of other portions in the outbound developed image and the inbound developed image of the wall surface of the tunnel.

FIG. 19B is a vertical edge histogram calculated by performing vertical edge extraction from a horizontal differential image acquired by differentiating the brightness value of the developed image of FIG. 19A in the horizontal direction. FIG. 19D is a vertical edge histogram calculated by performing vertical edge extraction from a horizontal differential image acquired by differentiating the brightness value of the developed image of FIG. 19C in the horizontal direction. In the vertical edge histograms of FIG. 19B and FIG. 19D, the horizontal image positions (i.e., the image positions in the moving direction) are plotted on the horizontal axis and the differential values are plotted on the vertical axis.

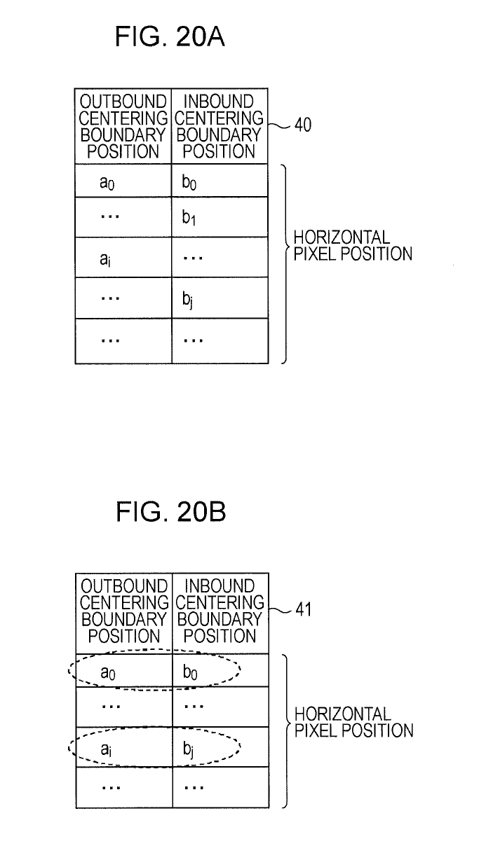

The horizontal pixel position which includes the peak not smaller than a predetermined threshold t is detected and is stored as the center boundary position. The center boundary position is recorded with an opening position of the tunnel being a reference position. FIG. 20A is a table 40 in which the horizontal image positions each including a peak not smaller than the predetermined threshold t are arranged vertically from the entrance to the outlet of the tunnel in a sequential order from among the vertical edge histograms of the outbound developed image and the inbound developed image. The centering boundary is observed as a line having a width on the image and thus the two peaks of the vertical edge histogram are observed at the center boundary position; it is also possible to register a mean value of the adjoining peaks with similar values.

Next, a correlation process of the center boundary positions of the outbound developed image and the inbound developed image is performed. FIG. 20B is a table 41 in which horizontal pixel positions at which the center boundary positions are within a predetermined range in the moving direction for each of the outbound and inbound developed images are extracted from the table 40 and arranged vertically. The correlation process may be performed in accordance with the moved amount of the vehicle from a tunnel opening reference position managed in synchronization with image data. The centering has specific intervals in accordance with the tunnel design specification; thus precision in correlation may be increased with reference to this information.

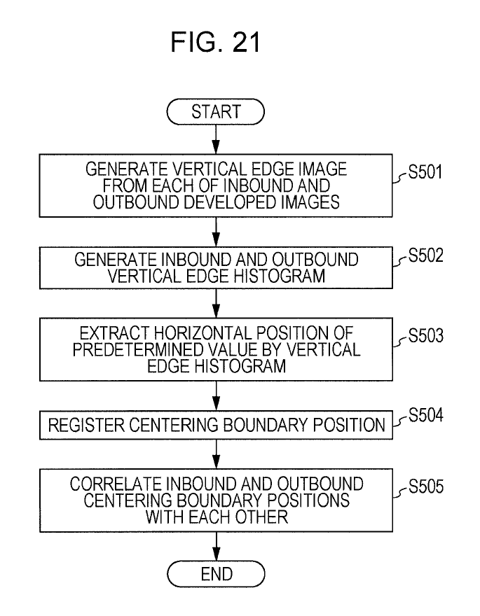

FIG. 21 is a flowchart illustrating detection of data of the centering boundary. A vertical edge image is generated from each of the outbound and inbound developed images (S501), outbound and inbound vertical edge histograms are generated (S502), in the vertical edge histogram, a horizontal image position of which differential value is not smaller than a predetermined value is extracted (S503), outbound and inbound center boundary positions are registered, respectively (S504), and the outbound and inbound center boundary positions are correlated with each other (S505).

The inwardly and outwardly developed image creation unit 28 generates an inbound and outbound developed image using the data correlated about the center boundary position of the outbound developed image and the inbound developed image. An embodiment of the inbound and outbound developed image generating process will be described hereinafter. Although a case in which the inbound developed image is joined with reference to the outbound developed image will be described, the outbound developed image may be joined with reference to the inbound developed image.

First Inbound and Outbound Developed Image Generating Process

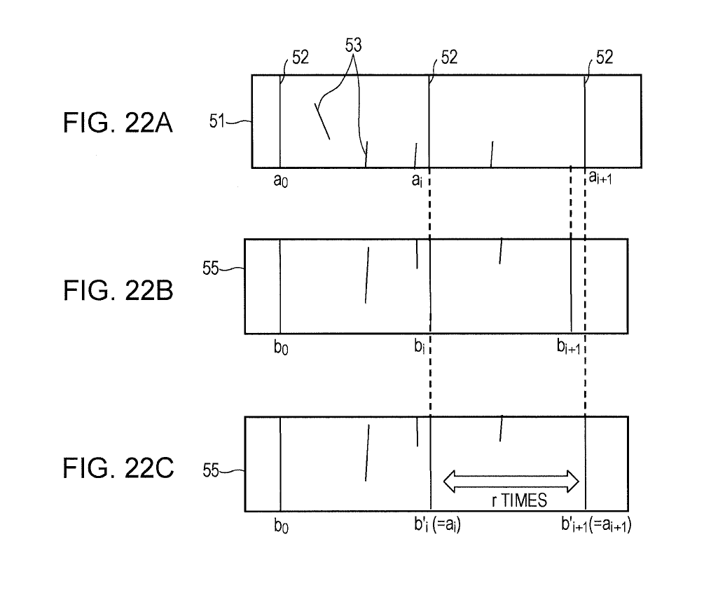

FIG. 22A illustrates an outbound developed image 51, FIG. 22B illustrates an inbound developed image 55 and FIG. 22C is an inbound developed image 55 acquired by performing an expansion and contraction of the inbound developed image.

[Step 1]

An image correction process of a partially developed image of the inbound centering boundary section [bi, bi+1] corresponding to the outbound centering boundary section [ai, ai+1] is performed. In particular, an expansion process to r times is performed in the moving direction as follows:

r=(ai+1−ai)/(bi+1−bi)

The expansion and contraction process to r times may be performed in the moving direction and in the scanning direction.

[Step 2]

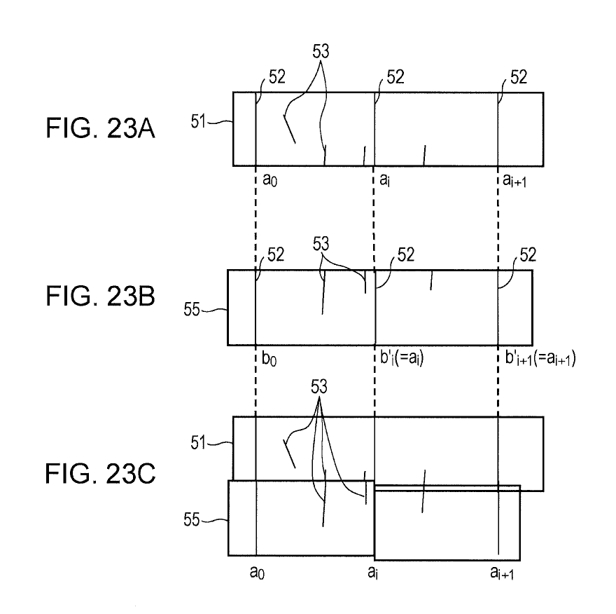

Next, the combination process of the outbound developed image 51 and the expanded and contracted inbound developed image 55 are performed. That is, an image search process is performed and the combination process is performed in accordance with the searched overlapping position. The combination process may be performed on a partially developed image basis. Since the combination process has been described with reference to FIGS. 16A to 16C and 17, description thereof will be omitted in the second embodiment. FIG. 23A is the outbound developed image 51 of the outbound developed image the same as that in FIG. 22A and FIG. 23B is the inbound developed image 55 for which the expansion and contraction process has been performed in the same manner as that in FIG. 22C. FIG. 23C is an inbound and outbound partially developed image acquired by combining the outbound developed image 51 and the inbound developed image 55 for which the expansion and contraction process has been performed.

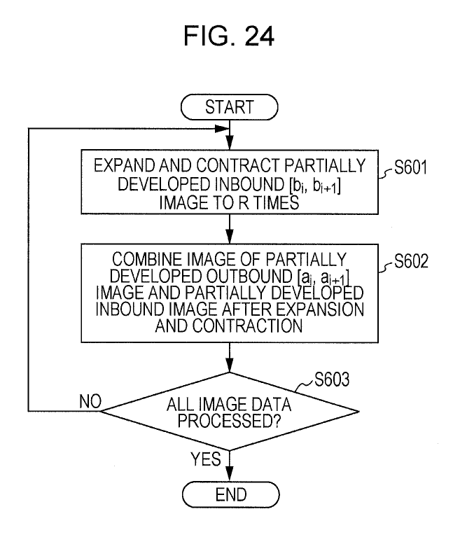

FIG. 24 is a flowchart of a first outbound developed image generating process. The expansion and contraction process is performed for the partially developed image of the inbound centering boundary section [bi, bi+1] to r times (S601) and a combination process is performed for the partially developed image of the outbound centering boundary section [ai, ai+1] and the inbound partially developed image after the expansion and contraction are completed (S602). S601 and S602 are repeated until all pieces of image data of the concrete wall surface situated between the centering boundaries are processed (S603).

Second Inbound and Outbound Developed Image Generating Process

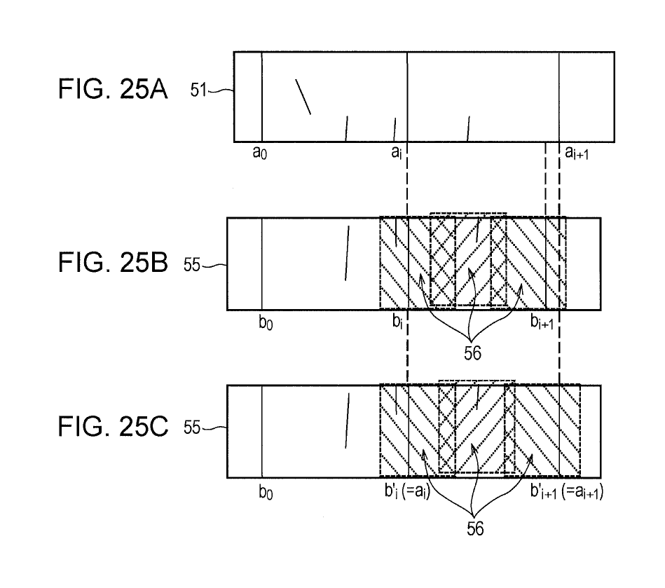

FIG. 25A illustrates an outbound developed image 51, FIG. 25B illustrates an inbound developed image 55 and FIG. 25C is an inbound developed image 55 acquired by performing a rearrangement process for the inbound developed image.

[Step 1]

The rearrangement process is performed for the partially developed image of the inbound centering boundary section [bi, bi+1] corresponding to the outbound centering boundary section [ai, ai+1]. In particular, the position of each of the image frames 56 which constitute the inbound developed image 55 is shifted in the moving direction by the following amount d.

d={(ai+1−ai)−(bi+1−bi)}/Ni

where Ni is the number of junctions of the frames in the moving direction which exists in the inbound centering boundary section [bi, bi+1]. For example, in the partially developed image of the centering boundary section [bi, bi+1] illustrated in FIG. 25B, the number of junctions of the frames Ni is 3.

The rearrangement process may not be performed to all the frame images which constitute the inbound partially developed image, but may be performed only to the following image frames: i.e., image frames stored in the inbound developed image generation process because the image search process has not been performed therefor due to an insufficient texture amount. In that case, the position of the image frame is shifted in the moving direction by the following amount d.

d={(ai+1−ai)−(bi+1−bi)}/Mi

where Mi is the number of frames for which the image search process has not been implemented in the outbound or inbound developed image generation process among the number of combined frames in the moving direction which exists in the inbound centering boundary section [bi, bi+1].

[Step 2]

Next, the combination process of the outbound developed image 51 and the rearranged inbound developed image 55 are performed. That is, the image search process is performed and, in accordance with searched overlapping positions, the combination process is performed in the same manner as in the first outbound developed image generating process.

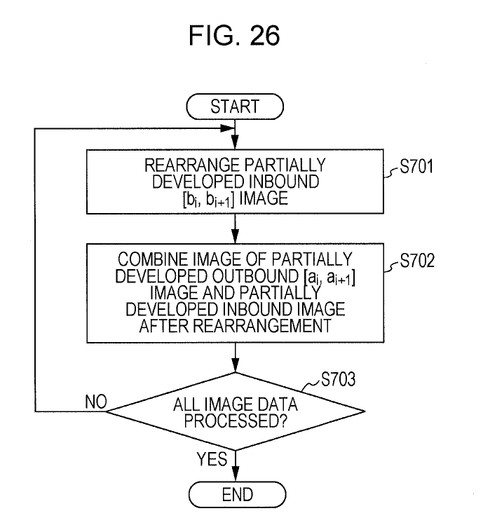

FIG. 26 is a flowchart of a second outbound developed image generating process. A rearrangement process is performed for the partially developed image of the inbound centering boundary section [bi, bi+1] (S701) and the combination process is performed for the partially developed image of the outbound centering boundary section [ai, ai+1] and the inbound partially developed image after the expansion and contraction are completed (S702). S701 and S702 are repeated until all pieces of image data of the concrete wall surface situated between the centering boundaries are processed (S703).

Note that, in [Step 2] of the above-described first and second inbound and outbound developed image generating processes, the image search process and the image combination process may be performed on the image frame basis, which image frames constitute the partially developed image such that the inbound developed image may be reconstructed.

According to the developed image generation device of the second embodiment, an inbound and outbound developed image of high quality may be generated by combining pieces of image data of the objects with reduced misalignment or variation in the entire inner wall of the tunnel. For example, inbound and outbound developed image of high quality may be generated even if the vehicle speed or the distance from the camera to the wall surface varies in the outbound and inbound travels.

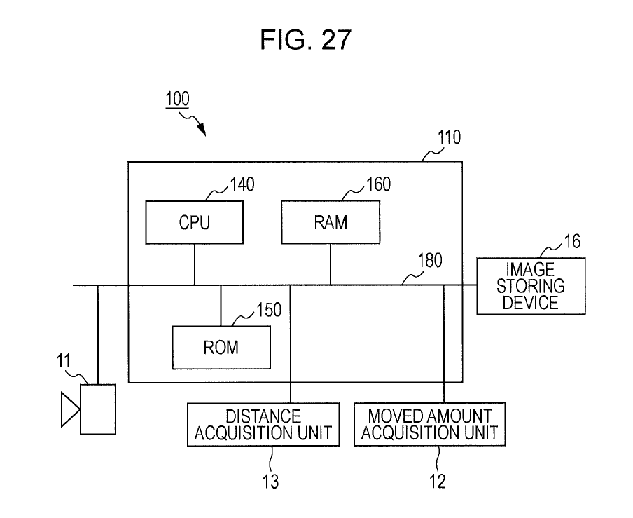

The image processing apparatus of the first embodiment and the second embodiment may be implemented using, for example, a general computer. FIG. 27 is a schematic diagram illustrating an exemplary image processing apparatus 100 of the first embodiment implemented using a general computer. The computer 110 includes a central processing unit (CPU) 140, read only memory (ROM) 150 and random access memory (RAM) 160. The CPU 140 is connected with ROM 150 and RAM 160 via a bus 180. The computer 110 is connected with the camera 11, the distance acquisition unit 13, the amount of movement acquisition unit 12 and the image storing device 16. The operation of the entire image processing apparatus 100 is collectively controlled by the CPU 140. The computer 110 performs the normalization process (i.e., the expansion and contraction process and the movement processing) and the combination process described above. The CPU 140 has a function to control the camera 11, the distance acquisition unit 13, the amount of movement acquisition unit 12 and the image storing device 16 in accordance with a predetermined program, and a function to perform various operations, such as the normalization process (i.e., the expansion and contraction process and the movement process) and the combination process described above. The RAM 160 is used as a program development area and a computing area of the CPU 140; and, at the same time, used as a temporary storage area of image data. Programs executed by the CPU 140, various types of data needed for the control, various constants/information about the operations of the camera 11, the distance acquisition unit 13, the amount of movement acquisition unit 12 and the image storing device 16, and other information are stored in the ROM 150.

The embodiment is not limited to that described above. Two or more embodiments may be combined without sacrificing consistency. The above-described embodiments are illustrative only; any embodiments having substantially the same configuration and similar operations and effects as those of the technical idea described in the claims are included in the technical scope of the above-described embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An image processing apparatus, comprising:
a camera which acquires an image of an area of an object while moving with a moving vehicle;
a moving amount acquisition unit which acquires a moving amount of the camera from a predetermined position on a moving path of the moving vehicle to an image acquiring position at which the camera acquires the image of the area;
a distance acquisition unit which acquires a distance between the area of the object and the camera when the camera acquires the image of the area;
a first processing unit which performs correction in which the image acquired by the camera is displaced in a moving direction of the moving vehicle in accordance with the moving amount;
a second processing unit which performs correction in which a size of the image acquired by the camera is changed in accordance with the distance acquired by the distance acquisition unit using a size of a predetermined image acquired by the camera and a distance corresponding to the predetermined image; and
a third processing unit which arranges a plurality of images corrected by the first processing unit and the second processing unit to generate an inspection image.

2. The image processing apparatus according to claim 1, wherein
the second processing unit includes:
a first change unit which changes the size of the image acquired by the camera in the moving direction; and
a second change unit which changes the size of the image acquired by the camera in a direction crossing the moving direction.

3. The image processing apparatus according to claim 2, wherein
the first change unit changes the size of the image corrected by the first processing unit.

4. The image processing apparatus according to claim 3, wherein
the second change unit changes the size of the image corrected by the first change unit.

5. The image processing apparatus according to claim 2, wherein
the second change unit changes the size of the image corrected by the first processing unit and the first change unit.

6. The image processing apparatus according to claim 1, further comprising
a scanning unit which moves the camera to scan the object in a scanning direction crossing the moving direction.

7. The image processing apparatus according to claim 2, wherein
the scanning direction is perpendicular to the moving direction.

8. The image processing apparatus according to claim 1, wherein
the distance acquisition unit is a distance sensor which measures the distance between the area of the object and the camera.

9. The image processing apparatus according to claim 8, wherein
the moving amount acquisition unit calculates the moving amount of the camera in accordance with an amount of displacement of a feature point of the image between a plurality of the images acquired by camera and the distance between the area of the object and the camera.

10. The image processing apparatus according to claim 1, wherein
the moving amount acquisition unit is a moving amount sensor which measures the moving amount of the camera in the moving direction.

11. The image processing apparatus according to claim 10, wherein
the distance acquisition unit calculates the distance between the area of the object and the camera in accordance with a distance from a center of the image to a feature point of the image and the moving amount of the camera.

12. The image processing apparatus according to claim 1, wherein
the object is an inner wall of a tunnel in which a plurality of parts are assembled together;
the moving direction of the camera is a direction from a first opening to a second opening of the tunnel; and
the image processing apparatus further includes
a detection unit which detects a image of a joint of the parts in a first inspection image of the inner wall generated by the third processing unit and a image of a joint of the parts in a second image of the inner wall generated by the third processing unit, and
a fourth processing unit which arranges the first inspection image and the second inspection image to generate a combination inspection image in accordance with the image of the joint in the first image and the image of the joint in second image.

13. An image processing method comprising:
acquiring image of an area of an object by a camera moving with a moving vehicle;
acquiring a moving amount of the camera from a predetermined position on a moving path of the moving vehicle to an image acquiring position at which the camera acquires the image of the area;
acquiring a distance between the area of the object and the camera when the camera acquires the image of the area;
performing, by a computer, first correction in which the image acquired by the camera is displaced in a moving direction of the moving vehicle in accordance with the moving amount;
performing second correction in which a size of the image acquired by the camera is changed in accordance with the distance acquired in the acquiring a distance using a size of a predetermined image acquired by the camera and a distance corresponding to the predetermined image; and
arranging a plurality of images corrected in the first correction and the second correction to generate an inspection image.

14. A computer-readable storage medium for storing an image processing program, the image processing program causing a computer to execute a process, the process comprising:
acquiring image of an area of an object by a camera moving with a moving vehicle;
acquiring a moving amount of the camera from a predetermined position on a moving path of the moving vehicle to an image acquiring position at which the camera acquires the image of the area;
acquiring a distance between the area of the object and the camera when the camera acquires the image of the area;
performing, by a computer, first correction in which the image acquired by the camera is displaced in a moving direction of the moving vehicle in accordance with the moving amount;
performing second correction in which a size of the image acquired by the camera is changed in accordance with the distance acquired in the acquiring a distance using a size of a predetermined image acquired by the camera and a distance corresponding to the predetermined image; and
arranging a plurality of images corrected in the first correction and the second correction to generate an inspection image.
